(19) United States
(12) Patent Application Publication
(10) Pub. No.: US 2022/0034645 A1
(43) Pub. Date: Feb. 3, 2022

(54) METHOD, INTERFEROMETER AND SIGNAL DEVICE, EACH FOR DETERMINING AN INPUT PHASE AND/OR AN INPUT AMPLITUDE OF AN INPUT LIGHT FIELD

(71) Applicant: Martin Berz, Munich (DE)

(72) Inventor: Martin Berz, Munich (DE)

(21) Appl. No.: 17/296,498

(22) PCT Filed: Nov. 27, 2019
(86) PCT No.: PCT/EP2019/082799

§ 371 Date: May 24, 2021

(30) Foreign Application Priority Data
Nov. 28, 2018 (DE) 10 2018 130 162.6

(51) Int. Cl. G01B 9/02

(52) U.S. Cl. CPC G01B 9/02061; G01B 2290/70; G01B 9/02097

(57) ABSTRACT

A method, an interferometer, and a signal processing device, each for determining an input phase and/or an input amplitude of an input light field, are disclosed. Here, an input light field is divided into a first light field and a second light field by amplitude splitting. The first light field and the second light field are propagated such that the propagated second light field is defocused relative to the propagated first light field. The propagated first light field is superimposed on the propagated light field and caused to interfere.

The present disclosure relates to a method for determining an input phase and/or an input amplitude of an input light field. Further, the disclosure relates to an interferometer and a signal processing device, respectively for determining an input phase and/or an input amplitude of an input light field. Further aspects of the present disclosure relate to uses of a method for determining an input phase and/or an input amplitude of an input light field.

Optical interferometers are sometimes used to reconstruct the phase and/or amplitude of a light field. For example, this enables a three-dimensional image reconstruction. In particular, the spatial position (e.g. the position and/or the structure) of the object or individual points of the object are to be determined from an intensity of a light field measured with a detector, which has interacted with an object.

In conventional optical systems, the problem often arises that the lateral resolution and/or axial resolution (i.e., depth of field) of the interferometer are limited, making image reconstruction difficult. In addition, with conventional interferometer setups that use an external reference beam (i.e., a reference beam that has not been affected by the object), one may be limited in the design of the optical system. These limitations are less with so-called self-reference systems, which do not use an external reference beam.

An object is to provide an improved method for determining an input phase and/or an input amplitude of an input light field in self-reference. Furthermore, an improved interferometer and an improved signal processing device, each for determining an input phase and/or an input amplitude of an input light field, are to be provided. In particular, the method may be applicable to incoherent light and/or to only partially coherent light.

According to at least one embodiment, a method described herein for determining an input phase and/or an input amplitude of an input light field comprises the following steps:
a) Amplitude splitting of the input light field into a first light field and a second light field;
b) Propagation of the first light field and the second light field such that the propagated second light field is defocused relative to the propagated first light field;
c) Amplitude superposition and imaging of the propagated first light field and of the propagated second light field onto a detector in such a way that in each case a first spot of the propagated first light field and a second spot of the propagated second light field interfere on the detector to form a common output spot of an output light field and the output light field generates an interference pattern at the detector,
wherein the respective first spot of the first light field and the respective second spot of the second light field interfering to a common output spot of the output light field originate from the same input spot of the input light field, and
wherein the output light field has at least three output spots for which applies:
   (i) the output light field is free from mutual coherence at different output spots of the at least three output spots, and
   (ii) the output light field exhibits at least partial spatial coherence within an output spot of the at least three output spots;
d) Measuring at least a portion of the interference pattern with the detector and determining a complex interference term from the measured interference pattern; and
e) At least partially determine the input phase and/or the input amplitude from the complex interference term.

Embodiments of a method described herein may find use in at least one of the following applications:
electronic focusing
Image correction, especially sharpening of an image;
Aberration correction of an optical system;
Measurement of the surface structure of a three-dimensional object;
Measurement of objects with temporally partially incoherent light sources and/or by means of photoluminescence;
Measurement of the structure of thin films;
Measurement of phase objects, especially phase sensitive bright field measurement or dark field microscopy;
Determination of the position of an object in a three-dimensional space.

According to at least one embodiment, an interferometer for determining an input phase and/or an input amplitude of an input light field comprises a splitting device, an imaging device, and a detector. The splitting device defines a first interferometer arm and a second interferometer arm, the second interferometer arm having a defocusing unit. The splitting device is adapted to split the input light field into a first light field and a second light field by amplitude splitting. The splitting device and the imaging device are arranged and adjusted to superimpose the first light field propagated along the first interferometer arm and the second light field propagated along the second interferometer arm by means of amplitude superposition and to image them onto the detector in such a way that in each case a first spot of the first light field and a second spot of the second light field interfere at the detector to form a common output spot of an output light field and the output light field generates an interference pattern at the detector. The detector is adapted to measure at least a portion of the interference pattern. The defocusing unit is adapted to defocus the second light field propagating along the second interferometer arm. The defocusing unit, the splitting device, the imaging device, and the detector are arranged and adjusted such that the output spot is incident on a plurality of spot pixels, wherein for at least 10% of the spot pixels a phase difference modulo 2π between the first light field and the second light field varies by more than 0.1π at the location of the spot pixels.

According to at least one embodiment, a signal processing device for determining an input phase and/or an input amplitude of an input light field comprises an input module, a memory module, and an evaluation module. The input module is adapted to determine a complex interference term from a signal originating from a detector. The memory module comprises a propagator mapping, wherein the propagator mapping describes a propagation of a first light field propagated along an optical path length into a second light field propagated along the optical path length, wherein the propagated second light field is defocused relative to the propagated first light field. Alternatively or additionally, the memory module may include at least one point spread function. The evaluation module is arranged to determine the input phase and/or the input amplitude of the input light field from the complex interference term and the propagator mapping and/or the point spread function.

Further aspects result from the patent claims, the description, the figures as well as the embodiments described in connection with the figures.

In the following, embodiments of a method described herein, an interferometer described herein, a signal processing device described herein, and uses described herein are explained. Reference is also made in part to figures for this purpose. In the figures, identical, like, similar, or like-acting elements are given the same reference signs. The figures and the proportions of the elements shown in the figures with respect to one another are not to be regarded as to scale.

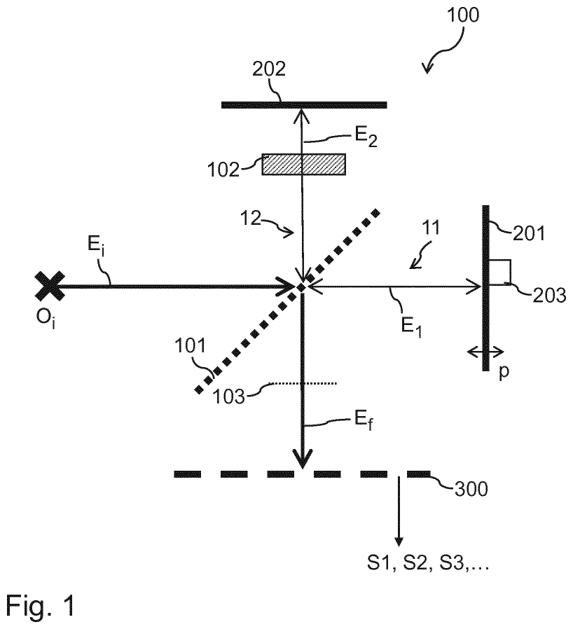

FIG. 1 schematically shows an example of an interferometer described here as well as a method described here.

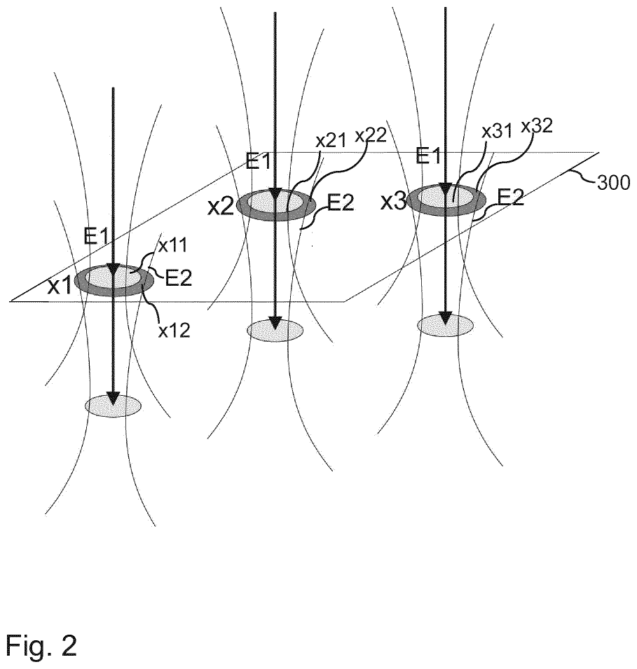

FIG. 2 schematically shows an axial displacement of two spots relative to each other.

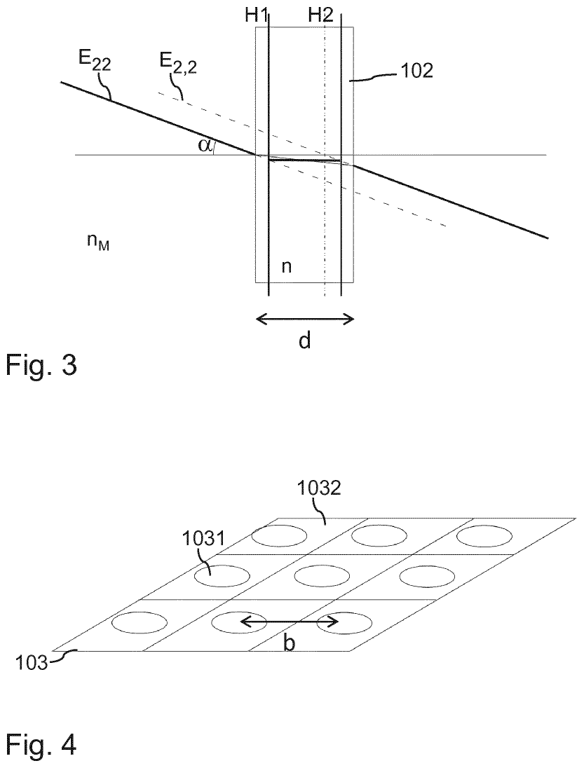

FIG. 3 schematically shows the construction of a principal plane.

FIG. 4 schematically shows a microlens array for an embodiment of an interferometer described herein.

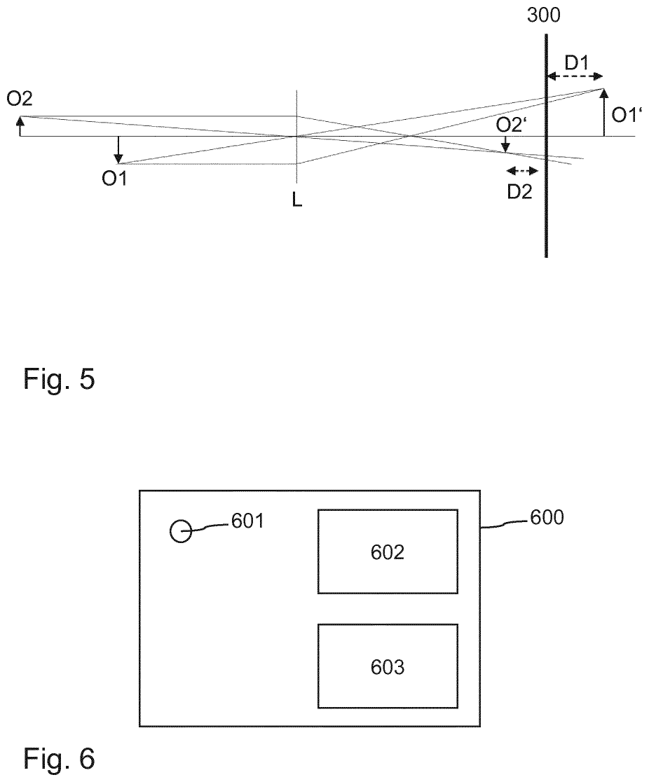

FIG. 5 schematically shows the displacement of a focal position of ray bundles.

FIG. 6 schematically shows an embodiment of a signal processing device described herein.

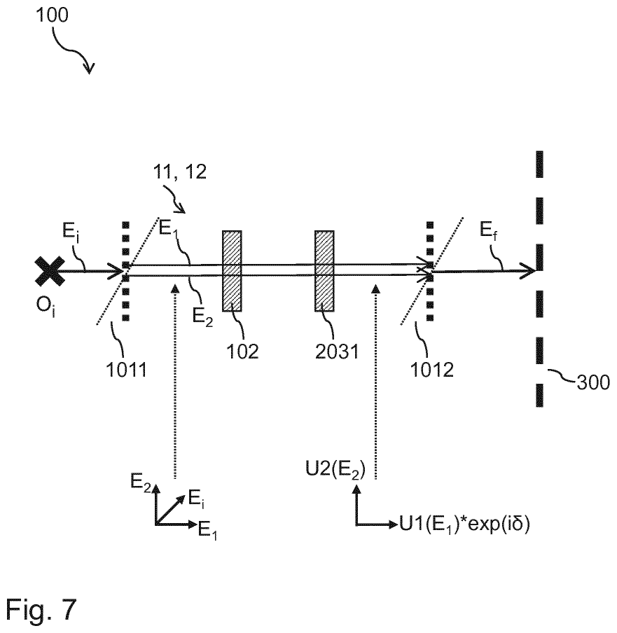

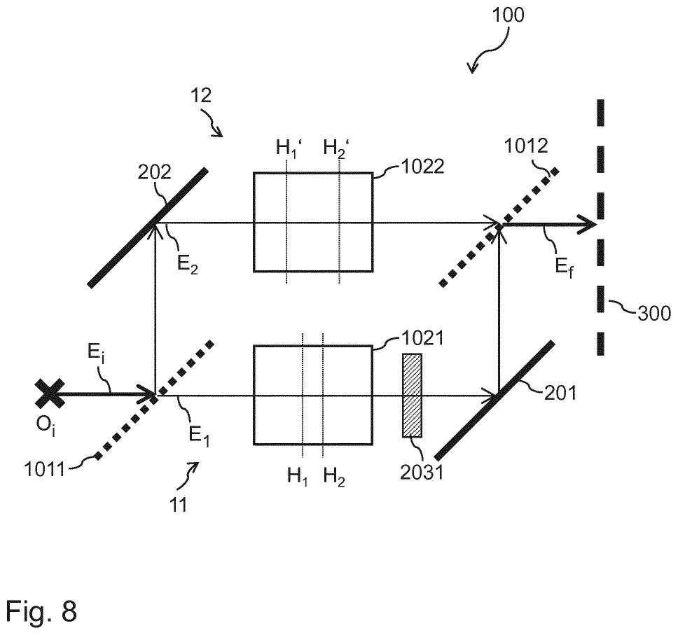

FIGS. 7 and 8 in each case show a schematic embodiment of an interferometer described herein and of a method described herein.

In particular, some of the embodiments of a method described herein may be carried out with embodiments of an interferometer described herein and/or with embodiments of a signal processing device described herein. That is, all features disclosed in connection with embodiments of the method are disclosed, mutatis mutandis, for embodiments of an interferometer and/or embodiments of a signal processing device, and vice versa.

Throughout the present disclosure, the use of the articles “one” and/or “the” may be understood to include both the singular and plural (in the sense of “at least one”), unless explicitly stated otherwise (e.g., by means of “exactly one”). The terms “comprise”, “contain”, “include”, “have”, etc., are inclusive and mean that other elements may be present in addition to those enumerated.

A method described herein may be arranged and/or suitable for determining an input phase and/or an input amplitude of an input light field. This means that the method may in particular be set up and/or suitable for determining the input phase and/or the input amplitude of at least one input spot of the input light field. The terms “phase”, “amplitude” and “light field” are used herein and hereinafter in their usual physical context. However, the method is not limited to visible electromagnetic radiation by the use of the term “light field”. Rather, non-visible electromagnetic radiation, such as infrared radiation and/or UV radiation, is also covered by the term “light field”. Furthermore, the principles described herein can be applied to other vector fields, such as particle radiation.

A “light field” (also called: field) can generally correspond to a ray bundle or a superposition of several ray bundles. In general, a light field consists of several mutually incoherent ray bundles. A ray bundle and/or a light field may be composed of a plurality of light rays (also referred to as: beams), each light ray corresponding to a propagation of a point of a cross-section of the ray bundle along the propagation direction. The cross-section may correspond to the wave front. Thus, each light ray may run perpendicular to the wave front. For example, a ray bundle is an approximately Gaussian ray bundle, where “approximately” in this context includes physical imperfections. For example, a ray bundle can be described by an electromagnetic vector field propagating along a propagation direction. Transversely, in particular perpendicularly, to the ray bundle, the ray bundle has a two-dimensional cross-section. Here and in the following, a z-direction in space can be the propagation direction, while the cross-section can be spanned by the x- and the y-direction.

At least one of the light fields described herein, in particular each of the light fields described herein, may be temporally and/or spatially coherent. In general, a light field may be emitted and/or generated by an object. The object may be, for example, a light source and/or an image. For example, the object may include at least one point source (e.g., a point light source—hereinafter also referred to as: “object point”). The object may be a superposition of many point sources, where each point source may be associated with an input light ray. In general, the object may emit temporally incoherent or temporally coherent light. Typically, the emitted light from a point source is spatially coherent and can be combined into a ray bundle. Typically, such a ray bundle corresponds to a subset of the light rays emitted by the point source. This subset may correspond to a particular solid angle segment. Typically, the light rays in such a ray bundle are coherent with each other, especially in the case of a point source. The emitted light from different object points may be incoherent to each other, both temporally and spatially. A point source may also be called and/or generate an input spot of the input light field. The object may actively emit light and/or an object may interact with a light field (e.g., by means of reflection), causing light to be emitted. In the case of a point source as an object, the point source may actively emit light and/or be a light emitting and/or reflecting point.

In the context of this application, it is possible that a second light field (E2) has arisen from a first light field (E1) by temporal and/or spatial displacement. In this case, the second light field can be described, for example, by the following equation (1):

E2(x+Δx, y+Δy, z+Δz, t+Δt)=E1(x, y, z, t), (1)

where a temporal shift can generally be generated via a path difference ΔL, i.e. Δt=ΔL/c (c is the speed of light). If a second light field generated in this way is coherent with the first light field for any parameters Δx, Δy, Δz, Δt (i.e., if there is interference), then the first light field can be said to be coherent. If coherence is not present for all parameters, but is present for at least some suitable parameters, the first light field is usually referred to as partially coherent. It is assumed here that at least one of the parameters Δx, Δy, Δz, Δt is different from zero. If one of the spatial parameters is different from zero, the light field is called (partially) spatially coherent. If Δt is different from zero, the second light field is called (partially) temporally coherent. In particular, the second light field may be spatially and temporally partially coherent. If there are no non-zero parameters Δx, Δy, Δz, Δt such that the first light field is partially coherent to the second light field, the second light field is called incoherent. This applies analogously to the first light field and/or to other light fields that transition to another light field via the above equation.

In the spatial coherence condition, for Δx, Δy, Δz the range of values may be limited to the size of the detector. Field points where the field is approximately zero are typically excluded. The field is approximately zero at a point if the intensity is at most 0.1 (or less than 0.05 or less than 0.01 or less than 0.001) of the maximum value of the intensity.

In the context of the present disclosure, it is possible for two light fields, e.g., two spots, to be superimposed (i.e., overlapped). The spots are coherent to each other if the superposition shows interference. The light fields, e.g. spots, are called incoherent to each other if the superposition shows no interference.

A light field imaged by means of an optical system usually contains at least one spot. A spot is in particular a coherent two-dimensional partial area of a light field. A spot can comprise several light rays of the ray bundle and/or can correspond to a ray bundle. In particular, a light field can be a superposition of several spots. In the case of an incoherent radiating object (e.g., several incoherent point sources), two different spots may be incoherent to each other.

A spot can result from the imaging of a (in particular single) point source as an object by means of imaging optics. The imaging may correspond to a propagation of the ray bundle corresponding to the spot. It is then possible that a spot is a so-called point spread function and/or the spot can be described by means of a point spread function. With appropriate knowledge of the optics used, it may be possible to determine the position of the object in space from the spot. The spot generated by means of imaging may be in focus in the plane conjugate to the plane of the object. In other planes, the spot can be out of focus. The spot can thus be a light field distribution on a sectional plane of the light field. Within a spot, the light field is coherent or at least partially coherent.

A light field (and in particular each light ray and/or each ray bundle and/or each spot of the light field) may have an amplitude, in particular a complex amplitude, the absolute square of which may correspond to an intensity. For the complex amplitude A applies: A=|A|·exp(iφ), where |A| is the modulus of the complex amplitude (hereinafter also just “amplitude”) and φ is the phase.

In at least one embodiment of the method, the method comprises an amplitude splitting of the input light field into a first light field and a second light field. In amplitude splitting, each light ray of an incident light field is divided into multiple (typically two) light rays. Each light ray of the incident light field is thus associated with several outgoing light fields, but with reduced intensity (amplitude). The amplitude splitting is typically done by using partially reflecting surfaces, where the reflection can be polarization dependent, by means of a grating or by means of a polarizer. In contrast, in wave front splitting, the light field is divided into different light rays, which can then be made to interfere. Here, each light ray of the incident light field is assigned to a single outgoing light field. The reverse process to amplitude splitting is amplitude superposition.

In at least one embodiment of the method, the method comprises propagation of the first light field and the second light field such that the propagated second light field is defocused relative to the propagated first light field. In particular, it is possible that the defocusing is generated by the propagation, and in some embodiments even generated exclusively by the propagation. For example, the first light field is propagated along a first interferometer arm and the second light field is propagated along a second interferometer arm. Propagation along the two interferometer arms may be free of imaging with an imaging system (e.g., with a lens).

Defocusing generally involves changing the axial position of the first light field relative to the second light field. Here it is possible that only the axial position of one of the two light fields or the axial position of both light fields is changed. Here it is possible that the relative lateral position of the two fields is not changed (no lateral displacement, also called “lateral shear”), but only the axial position. For example, it is possible that for each of the at least three output spots is not changed. Laterally, the spatial directions are normal to the propagation direction of the ray bundle. For example, the propagation direction of the ray bundle is chosen to be the propagation direction of the central ray. Conversely, a ray bundle is focused at a point if the rays of the ray bundle converge approximately at this point. The point is then called focal point. In the case of defocusing, the position of a focal point is spatially shifted, i.e. the previous focal point is now no longer a focal point. In a plane that previously contained the focal point, the light rays of the light field are now “fanned out”—the former focus thus corresponds to an enlarged light spot. Typically, however, the creation of the defocus is free of an imaging—only the position of the focus is shifted.

The light field can be defocused with a defocusing unit. The defocusing unit can be translation invariant with respect to lateral displacements (i.e. displacements perpendicular to the propagation direction) by a raster spacing. This means that a ray bundle that has been shifted laterally by the raster spacing will be modified by the defocusing unit in the same way as the ray bundle that has not been shifted. This is not the case, for example, when using a simple lens. This property may, for example, allow the first light field in the first interferometer arm to interfere with the second light field of the second interferometer arm after defocusing, regardless of any lateral displacement of the input light field, the first light field, and/or the second light field. In particular, the translational invariance applies to sufficiently large raster spacings and/or to integer multiples of the raster spacing. Such a rasterization of the defocusing unit is generally taken into account when evaluating the interference images.

One possible defocusing unit is an additional propagation distance (also called: geometric path length or propagation length), whereby the light field to be defocused undergoes additional propagation along the propagation direction. It is thus possible for the first light field and the second light field to traverse different geometric path lengths. The geometric path length can correspond to the geometric path, i.e. the direct distance between two points. In contrast, for the so-called optical path length, the refractive index of the medium through which the field propagates is usually additionally taken into account. When designing and/or adjusting the defocusing unit, the optical path length between the first interferometer arm and the second interferometer arm is in particular not changed. For example, the optical path length is kept constant or brought to an approximate optical path difference of zero. “Approximate zero” here means an optical path difference smaller than the coherence length. The coherence length of the light field used may be at most 1 m (or at most 1 mm, or at most 100 μm, or at most 10 μm, or at most 1 μm).

The propagation distance adjusted for the principal plane distances of the optical system is called the geometric propagation distance. The optical path length difference between the first interferometer arm and the second interferometer arm is typically not changed by the change of the geometric propagation distance compared to an interferometer with identical arms of the same length.

For example, this can be achieved by using dielectric layers and/or dielectric plates and the associated spacing of the principal planes in the optical system. As a result, the propagation distance and the optical path length are affected differently. The present disclosure is based on the fact that the propagation distance and the optical path length can be designed or influenced separately or independently by suitable optical means. In particular, the defocusing unit can be set up and/or adjusted and/or adjustable such that the first light field and the second light field pass through different propagation distances and identical optical path lengths.

The defocusing unit may alternatively or additionally include at least one of the following: (i) a lattice of microlenses, such as a two-dimensional lattice, the microlenses being spaced apart at the lattice spacing; (ii) a diffractive optical element (DOE) having a translation invariance orthogonal to the propagation direction;

In at least one embodiment, the method comprises amplitude superposition of the propagated first light field and the propagated second light field. In particular, the propagated first light field and the propagated second light field are amplitude superimposed to form an output light field. Further, the method comprises imaging the superimposed propagated first and second light field (and/or the output light field) onto a detector. The amplitude superposition and the amplitude imaging are performed such that a respective first spot of the propagated first light field and a respective second spot of the propagated second light field interfere on the detector to form a common output spot of an output light field and such that the output light field generates an interference pattern at the detector. Here, the respective first spot of the first light field and the respective second spot of the second light field interfering to a common output spot of the output light field originate from the same input spot of the input light field. The method may thus be translationally invariant, for example.

The (optical) image on the detector can be a projective image of the light field, except for aberrations. A propagator mapping can also be such a projective image. Such an image is usually produced by an optical system consisting of lenses, mirrors, prisms, and/or diffractive optical elements. Such an optical system is also called an imaging optical system. An imaging does not necessarily produce a real image, virtual images and/or defocused images are also possible. The latter is the case, for example, when the image is viewed in a plane which is a conjugate plane or approximately a conjugate plane of the optical system. An approximately conjugate plane or an approximately focal plane means that a radiating object point produces an intensity image point that is laterally magnified by defocus relative to the optimal focal plane by at least a factor of 2 (or 5, or 10, or 50). This conjugate plane may depend on the position of the object or point source from which the light field or ray bundle originates. In each case, when determining the focal position or conjugate plane, it is assumed that the light field is of the type emitted by an object with object points. Therefore, reference can be made to this object when constructing the focal position or the conjugate plane.

In a method described here, it is thus possible in particular for an input spot of an input light field to be caused to interfere quasi with its defocused self (so-called self-interference). It is possible that only the interference between a first spot of the first light field and a second spot of the second light field, which originate from the same input spot of the input light field, is considered to form one, in particular single, output spot of the output light field. It may be possible that only this interference occurs in the interferometer. In some embodiments, the method may be a so-called reference beam-free method. An external reference beam that has not interacted with the object is then not present.

A point with so-called zero interference is a point of the imaged output spot at which no phase difference exists between a corresponding light ray of the first light field and a corresponding light ray of the second light field, i.e. also no phase difference of 2π. A point with so-called approximate zero interference is a point analogous to the above, but a phase difference of an integer multiple of 2π may exist as far as the associated optical path difference is shorter than the coherence length of the light field. This corresponds to the situation where there are exactly (or nearly) equal oscillations for the first light field and the second light field from the emitting object point to the detector. This property can be independent of the wavelength, i.e. the term is also defined for temporally partially coherent light. In the case of strongly incoherent light or light with very short coherence length, the condition of approximate zero interference is restricted to the case of zero interference except for a vanishingly small deviation.

Due to chromatic aberration or the dependence of the refractive index on the wavelength in optical systems, the condition of zero interference should be fulfilled for all wavelengths occurring in the light field and/or which can be measured with the selected detector. It may therefore be necessary to perform a correction or compensation for chromatic aberration. Alternatively or in addition, it is possible to limit the spectral detection bandwidth of the detector. For this purpose, for example, at least one filter (for example, at least one spectral filter) can be used. The at least one filter may, for example, be placed at at least one of the following locations: in the beam path of the first light field (i.e., in the first interferometer arm), in the beam path of the second light field (i.e., in the second interferometer arm), in the beam path of the output light field (i.e., before the detector and after the two interferometer arms), and/or in the beam path of the input light field (i.e., after the object and before the two interferometer arms). For example, this makes it possible to enforce the allowable optical path differences for certain spectra.

Chromatic aberration, if not corrected, may substantially limit the visibility of the interference or prevent the measurability of the interference altogether. The criterion for the materiality of chromatic aberration is a resulting phase difference greater than 0.01 rad (or 0.1 rad, 0.2 rad, 0.5 rad, 1.0 rad, or even greater than πrad). In the interferometer described here, it may be possible that chromatic aberration is corrected to the extent that it is insignificant for the wavelength range used and detected. The light fields used have a spectral width that may correspond, for example, to the spectral width of one of the following light sources: a laser, a superluminescent diode, a light-emitting diode (LED), a luminescent dye, and/or a photoluminescent. A typical reference is an LED that has a linewidth (FWHM) of 30 nm±3 nm in the visible range (peak wavelength 600 nm). This corresponds to a coherence length of about 12 μm or even 20 wavelengths.

Analogously, the term ‘equal optical path length’ and ‘approximately equal optical path length’ is introduced. This is the case when the optical path difference is the same or approximately the same for each wavelength occurring or detected in the light field. Approximately means here that the optical path difference is smaller than the coherence length of this waveband.

The imaging may include or be a propagation of the output light field onto the detector. Alternatively or additionally, the imaging may include focusing the output light field onto the detector. The detector may comprise a plurality of pixels. The pixels are spatially separated from one another and are distinct. In particular, it is possible for each output spot to be imaged onto a plurality of pixels of the detector.

According to at least one embodiment of the method, the output light field has at least three output spots for which applies:
(i) the output light field is free from mutual coherence at different output spots of the at least three output spots, and
(ii) the output light field exhibits at least partial spatial coherence within an output spot of the at least three output spots.

Condition (i) above (free of mutual coherence) can be equated to the three output spots originating from different object points of the object. In particular, no interference is generated between the first light field and the second light field of one of the three output spots with the first light field and the second light field of another of the three output spots.

The above condition (ii) (partial spatial coherence) means in particular that within an output spot at least a partial, in case of complete coherence in particular a complete, interference of the corresponding first and second light field has been generated. Complete coherence of two light fields is given, for example, if the two light fields originate from one and the same light source (e.g. the same object point) and the optical path difference is smaller than the coherence length of the detected light field. In general, each output spot may originate from one, in particular a single, object point of the object. In this case, the output spot can be equated to a point spread function of the optical system used. The optical system used may be an interferometer described herein.

The coherence described above refers in particular to spatial coherence. In addition, effects can occur that affect temporal coherence. This is the case, for example, with influences of different wavelengths of the light. The visibility of the interference between the ray bundle in the first interferometer arm and in the second interferometer arm of the interferometer is enhanced or optimized by establishing an approximate zero interference for a point of the spot in the output field. In particular, the apparatus may be designed or arranged so that each spot in the output field and on the detector has a point of zero or approximate zero interference. This condition can be used to ensure that the entire output field can be measured with the same device or adjustment of the interferometer, and that different input spots do not have to be measured sequentially with different adjustments. For example, the interferometer allows simultaneous measurement of all ray bundles and/or input spots in the input field.

The point spread function generally describes the imaging of an idealized point-like object by an imaging optical system. The point spread function and/or a site-specific emission at a point of the input light field may correspond to the interference term of the interference of the first light field with the conjugate second light field, analogous to the complex interference term. For example, the point spread function depends on the spatial position of the object point (such as its axial distance from the detector or its lateral position with respect to the detector). The point spread function can be measured as part of a calibration, for example by using a test object with only one light emitting point. Alternatively or additionally, the point spread function can be calculated as far as the propagator mapping of the first light field onto the second light field is known.

In at least one embodiment, the method comprises measuring at least a portion of the interference pattern with the detector, in particular with its pixels. The measurement may be amplitude and/or phase resolved. The measured interference pattern is a function of the first light field and the second light field, and consequently of the input light field propagated through the (known) optical system of the two interferometer arms. The interference pattern may thus contain the phase information and the amplitude information of the input light field. Since the input light field has interacted with the object and/or has been emitted by the object, the measured interference pattern may thus contain required information about the structural setup and/or the position of the object in space. The object (in particular its structure and/or its position in space) can thus be reconstructed from the interference pattern. The optical system of the interferometer can, for example, be measured in a calibration measurement without the object, so that it is possible that only the object itself represents an unknown quantity.

A complex interference term can be determined from the measured interference pattern. The complex interference term (IF) is, for example, the product of the conjugate complex (conj) of the propagated second light field (E2) with the propagated first light field (E 1),

IF=con j(E2)·E1=|E1||E2|·exp i(φ1−φ2), (2)

where |E1| (|E2|) is the modulus of the propagated first light field (propagated second light field) and φ1 (φ2) is the phase of the propagated first light field (propagated second light field). Here, complete coherence of the first light field and the second light field with respect to each other was assumed in the region of observation. The light field may be a ray bundle emanating from an object point. For example, the viewing area is the area where both the first light field and the second light field are sufficiently different from zero. “Sufficiently different from zero” means that the absolute value of the first light field (i.e., |E1|) and/or the second light field (i.e., |E2|) is greater than 0.001 times (or 0.01 times, or 0.05 times, or 0.1 times) the maximum value of |E1| or |E2|, respectively.

In some embodiments, the interferometer may be arranged such that the common phase difference (i.e., φ1−φ2) for a general object point location is not constant, even approximately, in the viewing area. A general object point location is a point where neither the first light field in the first interferometer arm nor the second light field in the second interferometer arm are in focus on the detector. At the focus, the area where the respective magnitudes of the first light field and the second light field are sufficiently different from zero is minimal, and the common phase function of the first and second light fields can vary only slightly in this small area. However, by shifting the object point or detector, it is possible to bring about a constellation where both the first and second light fields on the detector are not, even approximately, in focus. This object point position is called a general object point position. The phase difference is not approximately constant if the phase difference varies by at least 0.01 rad (or 0.1 rad, 0.2 rad, 0.5 rad, 1.0 rad, or even by at least πrad) in the region of interest, not including phase jumps by 2π and/or continuing the phase difference steadily at the phase jump. The representation of the complex interference term in the form of equation (2) above will also be called the coherent interference term or complex point spread function in the following. The coherent interference term may correspond to a ray bundle or an associated spot in the input field or in the output field. Approximate complete coherence means that the path differences for all points in the observation area are smaller than the coherence length of the detected light field and that no effects of a restriction of the temporal coherence occur.

In at least one embodiment, the interferometer is arranged such that the variation or range of variation of the phase difference of the complex interference term in the viewing region does not occur due to a linear term in the phase difference. That is, it is valid that the variation or fluctuation width of the phase difference in the observation area occurs even if the phase function is corrected for a linear term, and is represented, for example, by the function φ1−φ2+a xₚ+b yₚ+c . Here xₚ and yₚ are the position values of the field on the detector (e.g. the Cartesian coordinates in the plane) and a, b, and c are parameters that can be freely chosen to check whether there is a linear dependence of the phase difference as a function of the position values of the field on the detector. Thus, it can be excluded that the phase variation of the phase difference in the viewing area is only the result of a different angle of incidence of the first and the second light field. Thus, for an interferometer described herein, it can be ensured that the variation of the phase difference is the result of a defocusing unit. A defocusing unit can produce a transformation of the light field corresponding, for example, to the application of Kirchhoff's diffraction integral and/or a solution of the Helmholtz equation. A mere change of direction is excluded by the above condition.

In addition to the complex interference pattern, the interference pattern measured at the detector also contains so-called self-interference terms, which can be determined by means of a calibration (e.g. by blocking the first or the second light field).

The complex interference term can be determined by the so-called “phase shifting” or “carrier-phase” method. In addition to the complex interference term, the entire interference pattern can also contain so-called self-interference terms (e.g. |E1|² and |E2|²). For the determination of the complex interference term, the complex interference term is typically determined without the self-interference terms. In this case, the complex interference term for a light field has the form according to equation (2) above. In the following, the complex interference term is understood to be the values without the self-interference terms.

If the light field contains several mutually incoherent ray bundles, a coherent interference term can exist for each of the ray bundles. When measuring the complex interference term, the sum of the influences of the coherent interference terms is recorded. The intensity (I) of the output field on the detector measured in this case can be represented as follows:

I=I_{back}+2·Re(IF) (3)

I_{back} is here the so-called incoherent background, which also contains the self-interference terms. IF is the complex interference term of which the real part (Re) is measured. For the complete determination of the complex interference term, it may be necessary to measure also the imaginary part. This can be determined, for example, by the so-called “phase shifting” or “carrier-phase” method. In the result IF is represented as:

IF=Re(IF)+i·Im(IF). (4)

For example, for three input spots that are incoherent to each other, the complex interference term can take the following form:

IF=|Eₐ₁||Eₐ₂|·e^{i(φ}^{ₐ₁}^{-φ}^{ₐ₂}⁾+|E_{b1}||E_{b2}|·e^{i(φ}^{_{b1}}^{-φ}^{_{b2}}⁾+|E_{c1}||E_{c2}|·e^{i(φ}^{_{c1}}^{-φ}^{_{c2}}^{).} (5)

Here, the indices a, b, c distinguish between the three different input spots, while the indices 1,2 distinguish between the first input light field and the second input light field generated from the respective input spot. In the exemplary case of three input spots, the complex interference term of equation (2) is transformed into the sum of three terms according to equation (5). Each of these three terms corresponds to a coherent interference term as shown in equation (2).

The complex interference term can be, for example, a superposition of the point spread functions or coherent interference terms of all object points imaged by means of the optical system used. That is, the complex interference term may be composed of the contributions of the individual emitters of the object. The determination of the contributions of the individual emitters of the object to the complex interference term can be equivalent to the digital generation of a hologram, where no reference beam, but a self-reference, is used.

The propagated first light field and the propagated second light field were propagated along a first interferometer arm and along a second interferometer arm, respectively, both known by design. The propagator images associated with these propagations may be known based on a calibration measurement. Alternatively or additionally, a library of coherent interference terms or complex point spread functions may be known based on a calibration measurement.

The method may further include at least partially determining the input phase and/or the input amplitude of the input light field from the complex interference term. “At least partially” here also includes an “at least approximately” determination of the input phase and/or the input amplitude. For example, the complex interference term is represented here as a weighted superposition of coherent interference terms. The weighting coefficient for each coherent interference term is a complex number. The superposition thus has an amplitude and a phase. The determination of the input phase and/or the input amplitude of the input light field can thus be represented as the determination of the complex weighting coefficients.

The representation of the complex interference term as a superposition of coherent interference terms or complex point spread functions can be unambiguous, depending on how many different complex point spread functions are allowed for the decomposition. The limit for uniqueness may correspond to the resolving power of the interferometer.

Possibilities for determining the complex interference term from an interference pattern and for determining the input phase from it are described, for example, in published patent application WO 2017/211 665 A1. The disclosure content of said patent application in this regard is hereby incorporated by reference back into the present application. Here, the main beam described in said patent application merges into the first light field and the described comparison beam merges into the second light field.

For determining the input phase and/or input amplitude, the complex interference term can be represented as a superposition of weighted partial interference terms. The partial interference terms can be complex (e.g. coherent) spot interference terms, complex pixel interference terms and/or point spread functions. The weighting of the individual terms of the superposition is typically based on amplitude. The amplitude is usually real, but can become imaginary when represented as a superposition. The complex problem of reconstructing the input phase can thus be transformed into reconstructing the phase of a superposition of the partial interference terms, similar to a Fourier analysis. More generally, the decomposition of the complex interference term can be understood as a development of a function into a sum of elementary basis functions.

In the case of determining the input phase or input amplitude, it is particularly possible that an IF phase or a complex interference term is determined first. The determination of the IF phase or a complex interference term may be equivalent to a measurement of the interference between the first light field and the second light field. In general, the complex interference term can be represented as a superposition of the interferences associated with the spots of the input light field. Decomposition of the complex interference term into the contributions of the individual spot interference terms may require a further evaluation step. From knowledge of the propagator mapping between the first light field and the second light field and/or knowledge of the point spread functions of the interferometer arms, a representation of the complex interference term as a superposition of individual spot interference terms can be made. This can correspond to an assignment of the complex interference terms to the point spread functions. The input phase of an incoherent field may be representable with reference to the input spots of the input light field.

In the method described here, it is possible that at least some of the light rays of the first light field are phase-shifted relative to the light rays of the second light field due to the defocusing. In particular, the defocusing and the subsequent propagation are selected such that for at least 10% of the spot pixels a phase difference between the first light field and the second light field at the location of the spot pixels varies by more than 0.1π (for example, by more than 0.2π, 0.5π, π or even more than 2π). Phase jumps are excluded in this case, for example, via the continuous continuation of the phase function. Alternatively or additionally, it is possible that a phase difference between the propagated first light field and the propagated second light field at at least 10% of the spot pixels is not equal to 2 k*π, with k=. . . −2,−1,0,1,2, . . . . In particular, there is no zero interference for at least one light ray of the output light field, not even approximately.

For example, the propagation (including defocusing) in step b) can be performed such that the first light field and the second light field traverse equal optical path lengths for at least one first spot of the first light field and at least one second spot of the second light field, except for a path difference required for interference. In particular, the first light field and the second light field traverse equal optical path lengths from the time of their generation from the common input light field (i.e., the amplitude splitting) to the time of their superposition to the output light field (i.e., the amplitude superposition), except for small shifts for interference. The characteristic “equal optical path lengths” of two spots and/or two light fields is given in particular if equal optical path lengths or approximately equal optical path lengths are present for at least one light ray of each of the two spots or the light field, in particular the central ray. The central ray is the light ray of a light field or ray bundle running along the central optical axis.

The optical path length is considered here and in the following along the optical propagation direction of the respective light field. The optical path length (also: “optical distance length”, L) of a medium through which a light field propagates is the integral over the refractive index of the medium (n(x)) along the metric propagation path (x):

L=∫n(x)dx. (6)

The geometric propagation distance is the metric propagation distance reduced by the areas between the principal planes. The differences of the geometric propagation distances can be used in the equations of geometric optics. The areas between the principal planes can be areas over which the ray bundles and/or the light rays of the ray bundles can be transported unchanged.

An optical path difference (also: path difference) is given when two paths have the same start and end point, but different optical path lengths.

In some embodiments of the method, the propagated second light field is shifted relative to the propagated first light field along an optical axis. The optical axis may be a central axis of an optical system used (e.g., an interferometer used). In particular, in an interferometer described herein, there may be a geometric path difference between the propagated first light field and the propagated second light field.

According to at least one embodiment, an additional adjustment device is used to adjust an optical path difference between the first light field and the second light field. The path difference may be at least a quarter of the wavelength of the input light field. The wavelength of the input light field corresponds to a peak wavelength of the input light field at which the input light field has a global maximum. The optical path difference can be used for the previously mentioned “phase shifting” method.

The input light field may be emitted and/or generated by an object having an imaging optical system. In some embodiments, it is possible that the input light field, with respect to a (real or virtual) section plane, is a superposition of mutually incoherent input spots of the input light field. The section plane may be, at least approximately, a conjugate plane of the imaging optical system of the object. The input spots of the input light field may, for example, originate from object points of the object imaged by means of the imaging optical system of the object.

In some embodiments of the method, a complex spot interference term is determined for each output spot. The complex spot interference term may correspond to a coherent interference term. The determination of the complex spot interference term may be analogous to the determination of the complex interference term described above, where the propagated first and second light fields are replaced by the corresponding first and second light fields of the affected output spot. The complex interference term is represented as a superposition of the complex spot interference terms and/or the complex interference term is a superposition of the complex spot interference terms.

In at least one embodiment, each output spot is mapped to a plurality of pixels of the detector. A complex pixel interference term is determined for each pixel, analogous to the spot interference term described above. The complex spot interference term consists of the values of the complex pixel interference terms. For example, the complex spot interference term is represented as a superposition of the complex pixel interference terms.

In general, different point sources are incoherent to each other. lithe input light field is generated by a plurality of point sources, interference is generally generated between two light rays of the input light field only if the two light rays are emitted from the same point source.

A point source is imaged by the interferometer as a spot. In the detector, each spot of the input light field can generate a spot interference term. Ideally, an explicit measurement of a spot interference term would be done in such a way that all other point sources are covered (i.e. “switched off”) during the measurement and thus only the single spot interference term is measured. Then only light from a single point source comes onto the detector and the spot interference term is isolated from all other possible point sources. Accordingly, this spot interference term can be represented in the form of equation (2) as a coherent interference term.

The complex spot interference terms closely approximate a point spread function of the interferometer used and may, for example, be physical representatives thereof. In some embodiments, the complex spot interference terms may correspond to a point spread function. The spot spread function may comprise complex pixel interference terms for each pixel.

Each output spot may have a width. The width may be, for example, a diameter of the output spot at the location of the detector, in particular the pixels of the detector.

In some embodiments, the propagated first light field and the propagated second light field, particularly in the form of the output light field, are imaged onto the detector such that the detector (particularly the pixels of the detector) is approximately in the image plane of the image. This is often referred to as the focus position or approximate focus position. Since the first and second light fields have different focus positions due to the defocusing device, the focus condition for the two light fields at the same time can only be approximately satisfied. For example, the image plane of the image for the first light field and/or the second light field deviates at least 0.1 mm (or at least 0.2 mm, 0.5 mm, 1 mm, 2 mm, 4 mm, or even at least 8 mm) from the position of the detector.

In at least one embodiment of the method, measuring the interference pattern includes measuring the phase and amplitude (i.e., intensity) of the interference pattern. This can be done for measurement of the entire interference pattern as well as for partial interference of a single output spot or pixel. In addition to a spatially resolved measurement, a spectrally resolved measurement of the amplitude is also possible.

In general, a coherent light field (E) can be represented as the real part of a complex-valued function:

E(x, y, z)=Re(A(x, y, z)·exp(φ(x, y, z)). (7)

Here A is the amplitude and φ the phase of the light field. Both functions are functions of the location (x,y,z). Since the electric field is also time-dependent, φ is determined only up to a global constant.

For example, the phase φ can be determined (i.e. measured) if the light field is spatially coherent. However, the light field may have a finite temporal coherence length (so-called partial temporal coherence).

If the light field is a superposition of ray bundles from different independent point sources, then the light field is usually spatially incoherent. Each of the point sources can then be assigned a light field (Eₖ) which can be represented according to the above equation (7), where each light field is assigned a phase (φₖ) and an amplitude (Aₖ).The phase can be determined to only one constant for each of the incoherent sources.

The interferometer can make it possible to measure the self-interference from each of the ray bundles. In the described superposition, all of these self-interferences can be measured simultaneously. The self-interference for each ray bundle can be measured if the optical path difference for the respective ray bundle is smaller than the coherence length for all points in the output spot. In particular, this is the case when approximately zero interference is set for a point in the output spot and when the variation of the phase difference across the output spot in the viewing area is less than the coherence length of the detected light divided by the wavelength. These conditions may be satisfied simultaneously for all ray bundles of the output field. If these conditions are fulfilled for all ray bundles of the output field simultaneously, then the present interferometer fulfills the so-called “global coherence condition” with respect to the coherence length of the detected light field. Embodiments of an interferometer described herein may satisfy the global coherence condition. The coherence length of the light field used may be less than 1 m (or less than 1 mm, or less than 100 μm, or less than 10 μm or less than 1 μm).

It is possible that the global phase factor of the incoherent emission source in the self-interference of the first and/or the second light field can be compensated by the product of the first light field with the conjugate complex of the second light field. The phase of the coherent interference term or the phase of the evolution coefficient in the decomposition of the complex interference term or the phase of the complex interference term of an object consisting of incoherent point sources can thus be uniquely determined. In case the same setting of the interferometer is chosen for the measurement or determination of the coherent interference terms of the point sources and the measurement of the complex interference term of the superposition or the total object, it can be achieved that the evolution coefficients of the decomposition of the complex interference term into the point contributions are real, i.e. have no imaginary part. This can significantly increase the accuracy or resolution.

For example, with the phase measurement the phases are determined, with the amplitude measurement the amplitudes, in particular the development decomposition of the complex interference term. As far as the possibly complex amplitude of the contribution of a coherent interference term is determined, the contribution of the coherent input field belonging to the coherent interference term is also determined. The amplitude of the field is thus determined or can be calculated from the amplitude of the evolution coefficient. The global phase of this coherent ray bundle can remain undetermined. The relative phase of the associated ray bundle, as well as the wave front of the associated ray bundle can be determined. Either the coherent interference term has been calculated, with which the input field used is known from the calculation process, or the coherent interference term has been measured, with which, according to the methods in published patent application WO 2017/211 665 A1, the input field can be calculated from the knowledge of the propagator mapping and the complex coherent interference term. For this purpose, it may be necessary to measure the intensities of the first light field and the second light field from the coherent interference term separately as part of the calibration.

For more complicated input fields, e.g., fields from optical systems with aberrations, the calculation path may not be viable and it may be necessary to measure the actual coherent interference term or the complex point spread function. Via the method in published patent application WO 2017/211 665 A1, the complex first light field can be determined from the measurement data, in particular from the coherent interference term. Thus, further complex point spread functions for other axial object distances can be generated from the measurement data, for example via electronic focusing. It is thus possible to calculate all required coherent interference terms or complex point spread functions via a few calibration steps (e.g. at most 5 measurements). This includes in particular coherent interference terms or complex point spread functions for different axial object distances.

It is possible that in a phase or amplitude determination of an input field, the complex interference term is determined in a first step. In a second step, e.g. with the evaluation module, the proportions of the individual point sources or ray bundles can be determined.

In some embodiments, a method described herein may be used for electronic focusing, image correction (especially sharpening an image), and/or aberration correction of an optical system. Here, an image imaged by means of another imaging device may serve as the object. By means of the method it may thus be possible to post-process images.

Some embodiments of a method described herein are suitable for measuring surface structures of a three-dimensional object. Furthermore, the measurement of objects with temporally partially incoherent light sources and/or by means of photoluminescence is possible. Here, a suppression of the so-called speckle noise becomes possible by means of the method described herein. Further uses of embodiments of a method described herein relate to the measurement of phase objects, in particular phase-sensitive bright-field measurement or dark-field microscopy, and the determination of the position of an object in a three-dimensional space, for example a 3D profiler.

In general, embodiments of a method described herein may be used for object reconstruction. Object reconstruction is the process of representing a measured light field as a superposition of spots, where for each spot the intensity, electric field, 3D—position of a generating point light source and/or equivalent information (such as a self-correlation function) has been determined. Typically, no object reconstruction is possible from a conventional intensity image of a camera.

Object reconstruction from the complex interference term is generally understood to mean the determination of the 3D position of the object, in particular the point sources or object points of the object, and/or the determination of the intensities of the object points of the object.

In at least some embodiments, the method is used for image correction and/or electronic focusing of an image. The image to be corrected was imaged and captured using an imaging device that is not part of the interferometer used for the method. The image to be corrected was imaged near a focus of the imaging device, but not at the focus of the imaging device. Thus, it may be possible to refocus a slightly defocused image.

In general, “near focus” can be understood as follows: the entire optical system comprises an imaging device which is not part of the disclosed interferometer and an interferometer according to the disclosure having a detector in the detection plane. For example, the image to be corrected originates from an object (or an object spot) imaged by means of the imaging device, the spot generated by the imaging being picked up by means of the detector of the imaging device. A spot on a detector of the imaging device approximates a focal location (i.e., is “near focus”) if the plane of the detector is approximately a conjugate plane to the plane of the object. For example, the position of the object when imaged with the imaging device may be at least 1 μm (or at least 5 μm or at least 10 μm) and/or at most 100 μm (or at most 50 μm, or at most 20 μm) away from a position of the focus of the imaging device.

“Close to focus” can be understood, for example, as follows. For example, the output field of the interferometer includes the superposition of the first light field and the second light field. Due to the defocusing unit, the focal positions for these two light fields are axially different, and therefore the focus condition for these two light fields cannot be satisfied simultaneously. The “near focus” condition can be specified as follows: a spot of the first light field and/or the second light field can each have a spot diameter at the detector of at most twice (or at most 5 times, 10 times, 20 times, 50 times, 100 times, or 500 times) a minimum possible diameter of the spot (taking into account any aberrations that may be present). In each case, the spot diameter of the first light field (second light field) can be measured with the second interferometer arm (first interferometer arm) blocked. The minimum possible diameter of the spot is given in particular by the imaging device and can be determined, for example, by means of a point spread function of the imaging device.

Alternatively or additionally, the position of the spot of the first light field and/or the second light field and/or the position of the self-interference term on the detector may deviate by at least 1 μm (or at least 10 μm, 100 μm, 1 mm, 2 mm, 4 mm, 8 mm or 16 mm) from the focal plane of the first light field or the second light field, respectively, with only the greater distance being taken from the distances of the first light field and the second light field, respectively. Therefore, when applying the imaging optics to the interferometer, it is not necessary to “focus” on a specific detection plane. An approximate focusing is sufficient.

In some embodiments, use of a method described herein may include deconvolution of an image and a point spread function. The image may have been measured and/or represented as a complex interference term.

According to some embodiments, an interferometer for determining an input phase and/or an input amplitude of an input light field comprises a splitting device, an imaging device, and a detector.

The splitting device defines a first interferometer arm and a second interferometer arm, the second interferometer arm having a defocusing unit. The first interferometer arm may optionally also include a defocusing unit. The splitting device may include a plurality of optics (such as imaging and/or defocusing optics). The first interferometer arm and the second interferometer arm are defined, for example, by optical inputs and/or outputs of the splitting device. The splitting device may have only a single amplitude splitter (e.g., a beam splitter and/or a polarizer), or may have multiple or at least one amplitude splitter (e.g., a beam splitter and/or a polarizer) at the beginning of the interferometer arms and an amplitude superimposer (e.g., a beam splitter and/or a polarizer) at the end of the two interferometer arms. The interferometer arms can be spatially separated or superimposed, e.g. similar to the setup of a Michelson interferometer.

The splitting device is set up to split the input light field into a first light field and a second light field by means of amplitude splitting. For this purpose, the splitting device can have an amplitude splitter.

The splitting device and the imaging device are set up and adjusted to superimpose the first light field propagated along the first interferometer arm and the second light field propagated along the second interferometer arm by means of amplitude superposition and to image them onto the detector in such a way that in each case a first spot of the first light field and in each case a second spot of the second light field interfere at the detector to form a common output spot of an output light field and the output light field generates an interference pattern at the detector. For example, the splitting device may include an amplitude superimposer for this purpose, which may be different from or identical to the amplitude splitter. Further, it is possible for the first and second interferometer arms and/or the splitting device to include other optics, such as mirrors. Further, the imaging device may include imaging optics, such as a lens.

The detector is arranged to measure at least a portion of the interference pattern. The defocusing unit is adapted to defocus the second light field propagating along the second interferometer arm relative to the first light field. The defocusing may include, for example, an axial displacement of the second light field relative to the first light field. Axial here refers to the direction of propagation of a ray bundle from the light field, typically the central ray. Optionally, a further defocusing unit present in the first interferometer arm may also defocus the first light field.

The defocusing unit, the splitting device, the imaging device and the detector are set up and adjusted such that the output spot impinges on a plurality of spot pixels, wherein for at least 10% of the spot pixels in the viewing area there is a variation of the phase difference between the first light field and the second light field at the location of the spot pixels by more than 0.1π (or by more than 0.5π or by more than π), wherein the phase is continuously continued, i.e. 2π phase jumps are excluded. Alternatively or additionally, it is possible that the defocusing unit, the splitting device, the imaging device and the detector are set up and adjusted such that the output spot is incident on a plurality of spot pixels, wherein for at least 10% of the spot pixels a phase difference between the first light field and the second light field at the location of the spot pixels varies by not equal to 2 k π(k=. . . −2,−1,0,1,2, . . . ). In other words, for at least 10% of the spot pixels, a real part and an imaginary part exist simultaneously in the interference pattern of the output spot, so that interference is possible. The phase variation can be a result of defocusing. In this case, the central ray may have zero interference or approximately zero interference, or IF is adjusted in phase accordingly. For example, at least one of the above conditions holds for at least 10% (or at least 20% or even at least 50%) of the spot pixels.

In some embodiments of the interferometer, the defocusing unit comprises or consists of at least one of the following components: a dielectric medium, in particular a dielectric plate; a refractive system, in particular a lens; a diffractive system with a translational symmetry, in particular a grating; an adjustable mirror, in particular a piezo-adjustable mirror. The dielectric medium can have an adjustable refractive index and/or it can be rotated so that the light field passes through it at an angle and travels a different length of path in the dielectric depending on the angle of passage.

In some embodiments, the defocusing unit, the splitting device, the imaging device, and the detector are set up and adjusted such that the output light field has at least three output spots. The three output spots can be imaged onto different areas of the detector. For the at least three output spots the following applies:

the output light field is free from mutual coherence at different output spots of the at least three output spots, and

the output light field exhibits at least partial spatial coherence within an output spot of the at least three output spots.

Conditions (i) and (ii) have already been explained in connection with embodiments of the method.

The defocusing unit, the splitting device, the imaging device, and the detector may further be set up and adjusted such that the respective first spot of the first light field and the respective second spot of the second light field, which interfere to form a common output spot of the output light field, originate from the same input spot of the input light field.

In some embodiments of the interferometer, the defocusing unit or other device, such as a piezo-adjustable mirror or a phase shifter, is arranged to change the optical path length of the second interferometer arm. For example, the optical path length of the second interferometer arm is changed relative to the optical path length of the first interferometer arm.

In some embodiments of the interferometer, the geometric propagation distance of the second interferometer arm differs from the geometric propagation distance of the first interferometer arm by at least 0.1 mm, (or at least 0.2 mm, 0.5 mm , 1 mm, 3 mm, 5 mm, or even at least 10 mm). For example, the geometric propagation distance of the second interferometer arm is longer than the geometric propagation distance of the first interferometer arm.

Alternatively or additionally, it is possible that the optical path length of the first interferometer arm is approximately indistinguishable from the optical path length of the second interferometer arm. This may mean that there is a point on the detector with approximately zero interference.

The geometric propagation distance is the geometric length of the path along which propagation occurs. The geometric propagation distance is reduced compared to the metric length by the distance of the principal planes. Along the geometric propagation path, the mapping is done according to geometric optics.

Propagation generally refers to the propagation of the light field, i.e. the further development and/or propagation of a light field from an initial plane to an end plane. For the physical modeling of the process, for example, Kirchhoff's diffraction integral can be used and/or a solution of the Helmholtz equation. Alternatively, the propagation can be calculated according to the rules of geometrical optics or by so-called ray-tracing. The geometric path length in a dielectric medium through which a light field propagates can be the quotient of the metric path length of the medium and the mean refractive index of the medium. The geometric path length accounts for principal plane effects. The geometric path length can be the metric length of the medium along the propagation direction, reduced by the regions between the principal planes.

According to at least one embodiment of the interferometer, the interferometer is arranged such that the interference pattern is a superposition of a plurality of spot interference patterns of the output spots. The detector is arranged to measure the phase and amplitude of the spot interference patterns and/or the interference pattern.

According to at least one embodiment of the interferometer, the splitting device is arranged and adjusted to split the input light field by means of amplitude splitting and to superimpose the propagated first light field and the propagated second light field by means of amplitude superposition. For example, the splitting device includes at least one beam splitter.

In some embodiments, a signal processing device for determining an input phase and/or an input amplitude of an input light field includes an input module, a memory module, and an evaluation module. The input module is adapted to determine a complex interference term from a signal originating from a detector.

The memory module comprises a propagator mapping and/or a point spread function, wherein the propagator mapping describes a propagation of a first light field propagated along an optical path length into a second light field propagated along the optical path length, wherein the propagated second light field is defocused relative to the propagated first light field. The propagator mapping may be, in particular, a point spread function describing said propagation. The point spread function may correspond to the propagator mapping.

The evaluation module is set up to determine the input phase and/or the input amplitude of the input light field from the complex interference term and the propagator mapping and/or the point spread function. For this purpose, the evaluation module can use a reference database in addition to the complex interference term.

The signal processing device may be, in particular, a computer having appropriate inputs and outputs for communication with the detector.

In some embodiments, the memory module comprises a reference database, wherein the reference database comprises complex comparison interference terms, wherein the complex comparison interference terms have been determined by means of calculation and/or calibration, and wherein the evaluation module is arranged to determine the complex interference term from the signal by means of comparison with the complex comparison interference terms. The comparison interference terms can be, for example, point spread functions. The determination of the complex interference term can include a determination of proportional contributions of different point spread functions to the complex interference term.

A possible method for determining the decomposition of the complex interference term into the proportional contributions of different spot spread functions is a representation as a convolution between a for the time being unknown amplitude for the spot position and a complex spot spread function (or a complex spot interference term). The convolution corresponds to a multiplication in Fourier space. That is to say, by representation of the problem in the Fourier space the Fourier transform of the for the time being unknown amplitude can be determined from the quotient of the Fourier transform of the complex interference term and the Fourier transform of the complex spot spread function. The originally searched amplitude function can be determined by a Fourier transform. The procedure assumes that all point spread functions can be generated by lateral translation from a reference point spread function. This is approximately the case if all object points lie in the same plane. Otherwise it is necessary to use different reconvolutions for different parts of the image or to use a different method at all. In general, the solution task consists of the solution of a linear equation, which can also be solved without reference to a convolution.

A computer program is further disclosed. The computer program is adapted to determine a complex interference term from a signal originating from a detector. Further, the computer program is adapted to determine the input phase and/or the input amplitude of the input light field from the complex interference term and a propagator mapping and/or a point spread function.

FIG. 1 schematically illustrates an interferometer 100 according to an exemplary embodiment. The structure shown in FIG. 1 is similar to that of a Michelson interferometer. The interferometer 100 has a splitting device 101, which in the present case functions both as an amplitude splitter and as an amplitude superimposer. In the embodiment shown, the splitting device 101 is a beam splitter. An input light field Ei originating from an object Oi can be divided into a first light field E1 and a second light field E2 by amplitude splitting using the splitting device 101. The first light field E1 then propagates along a first interferometer arm 11 and the second light field E2 propagates along a second interferometer arm 12. After propagation, the two light fields E1, E2 can be superimposed by means of amplitude superposition at the splitting device 101 to form an output light field Ef.

The first interferometer arm 11 includes a first mirror 201 that can be shifted by a displacement p along the propagation direction of the first light field E1 by means of a piezo element 203. The first mirror 201 and the piezoelectric element 203 thus act together as a phase shifter. The optical path length of the first interferometer arm 11 is changed such that the optical path length of the first interferometer arm 11 corresponds to the optical path length of the second interferometer arm 12. Via the piezoelectric element 203 it is possible to stabilize the optical path length difference to zero interference for a selected point of a selected ray bundle. For the above mentioned “phase shifting” the optical path length is varied, for example, by various values in the range 0 to 2π.

The second interferometer arm 12 includes a second mirror 202 and a defocusing unit 102. In the example shown, the defocusing unit 102 is a dielectric plate having a refractive index (n) greater than the refractive index of the surrounding medium (e.g., air). By means of the dielectric plate, the optical path length of the second interferometer arm 12 can be extended and the geometric path length of the second interferometer arm 12 can be shortened.

After passing through the first interferometer arm 11 and the second interferometer arm 12, respectively, the first light field E1 and the second light field E2 are superimposed by means of the splitting device 101 to form an output light field Ef and brought to interference on a detector 300. The detector 300 may be a CCD sensor, for example. The output light field Ef can be imaged onto the detector 300 by means of an optional imaging device 103. Merely as an example, the imaging device 103 is inserted between the splitting device 101 and the detector 300. However, it is possible to place the imaging device 103 in one of the two interferometer arms 11, 12. Then the imaging device 103 acts only on the field E1 or E2. The imaging device 103 may be a lens (e.g., a microlens array). However, it is also possible that the imaging device 103 only generates a propagation of the output light field Ef and/or redirects the output light field Ef to the detector 300. By means of the detector 300 the interference pattern is measured and an input signal S1, S2, S3 is provided for an optional evaluation device (also: signal processing device, cf. e.g. FIG. 6).

The design of the interferometer 100 shown in FIG. 1 allows a first spot of the first light field E1 to interfere with a second spot of the second light field E2 (see also FIG. 2).

FIG. 2 schematically shows the interference of three spots x1, x2, x3 of the output light field Ef on the detector 300. The choice of the number of spots x1, x2, x3 shown is purely exemplary—four or more spots are also possible. Each of the three spots x1, x2, x3 is formed from an interference of a first spot x11, x21, x31 of the first light field E1 and a second spot x12, x22, x32 of the second light field E2. Purely by way of example, each spot x11, x12, x21, x22, x31, x32 is represented as a Gaussian or Gaussian-like ray bundle, with the region of the smallest steel diameter corresponding to the optimum focus.

As shown in FIG. 2, the spots x11, x12, x21, x22, x31, x32 of the two light fields E1, E2 are axially shifted with respect to each other—the second light field E2 is thus defocused compared to the first light field E1. As a result, each spot x11, x12, x21, x22, x31, x32 of the first light field E1 and/or of the second light field E2 comes to interference quasi with a replication of itself, but with a different focal position. Thus, an interference of two ray bundles, which are coherent with each other, is generated.

For neither of the two light fields E1, E2 a focus condition on the detector 300 is necessarily met. That is, it is not necessary that the spots of the first light field E1 and/or the second light field E2 hit the detector 300 in focus. Both light fields E1, E2 may be “out of focus” at the detector 300. However, they have usually traversed the same optical path length, i.e., even in the case of short temporal coherence and/or short optical coherence length (e.g., in the case of so-called ‘incoherent light’), the two rays come to interfere. The condition of superposition and interference can be fulfilled for all ray bundles (which are spatially incoherent to each other) at the same time.

With reference to the schematic diagram of FIG. 3, a geometric method for constructing principal planes is explained. Shown is a defocusing unit 102 designed as a plane-parallel dielectric plate with a thickness d and a refractive index n as well as its principal planes H1, H2. Furthermore, the ray paths of two light rays E21, E22 of the second light field E2 through the defocusing unit 102 are shown purely by way of example.

The system is a telecentric system in which the principal planes H1, H2 are located inside the plane-parallel plate for a refractive index n>n_{M}. n_{M} is the refractive index of the surrounding medium, which is set to 1 in the following purely as an example (refractive index of air), although other media are also possible.

The optical path length is extended by the value of (n−1)*d by inserting the defocusing unit 102. The distance between the two principal planes is (1−1/n)*d. While the optical path length is extended by the dielectric medium, the geometric propagation distance is shortened by the distance between the two principal planes.

In contrast, a pure extension of the path length in the medium—i.e. without the introduction of a dielectric plate—by the thickness d would also lead to an extension of the geometric path length, but the optical propagation distance would also be extended. In the case of an incoherent light field, this leads to the fact that no interferences can be measured, as far as the path length extension is larger than the coherence length. Coherence lengths for fields considered in the present disclosure can be in the range of a few μm, i.e. the defocusing unit cannot function via a mere extension of the path length.

For an exemplary thickness of the dielectric plate of 1 mm, executed in e.g. BK7 glass, there is an appreciable chromatic aberration in the visible range. The Abbe number of BK7 is 64.2, and for a linewidth of 30 nm at a centre wavelength of 630 nm, there is an optical path difference across the linewidth of 0.5 μm (4 rad). The linewidth corresponds to the theoretical linewidth of a light-emitting diode (LED). Thus, an LED light field is not suitable for an interferometer designed in this way for a measurement of the interference.

Chromatic correction can be enabled by installing at least one defocusing unit 102 in each of the two interferometer arms 11, 12 (e.g., in the embodiment example of FIG. 1) (not shown in the figures). Each of the defocusing units 102 may comprise a dielectric plate, which may be rotatable for dispersion adjustment. If one defocusing unit 102 is installed in each of the interferometer arms 11, 12, the defocusing unit 102 for the first interferometer arm 11 may be made with a different dielectric than the defocusing unit 102 in the second interferometer arm 12. For example, BK7 glass (thickness d2, refractive index n2) may be used in the second interferometer arm 12 and CaF2 glass (thickness d1, refractive index n1) with an Abbe number of about 95 may be used in the first interferometer arm 11. For example, the thickness of the two dielectric plates is chosen so that the term n1(λ)*d1−n2(λ)*d2 is approximately constant. This results in a given thickness ratio d1/d2. Due to the different geometric path lengths, there is a net effect corresponding to a chromatically corrected defocus unit 102.

FIG. 4 shows a purely exemplary imaging device 103 designed as a microlens array. The imaging device 103 comprises a plurality of lenses 1031 which are connected to each other at a grid spacing b by means of an array material 1032. By means of a microlens array, it is possible, for example, to change the interference situation for a gridded matrix of pixels.

FIG. 5 shows purely exemplarily for a simple optical setup how the position of different object points O1, O2 leads to different ray bundles on the detector, and how the different axial positions lead to different focal positions of the respective ray bundle relative to the detector. Shown is the situation for a first object point O1 and a second object point O2. The first object point O1 and the second object point O2 are imaged with a lens L onto a first image point O1′ and a second image point O2′, respectively. The different axial position of the two object points O1, O2 leads to a defocus D1, D2 of the images relative to the image plane (first defocus D1 and second defocus D2). Shown for clarity is only the situation for one interferometer arm, i.e. for example for the first interferometer arm. The deflections in the interferometer are also not drawn. I.e. the scheme corresponds to a tunnel diagram with unfolded ray paths. The situation for the second interferometer arm is analogous, but due to the defocusing unit the position of the foci are different. This is taken into account by the evaluation unit, where the basis of the evaluation is the complex interference term. An interferometer described here allows to resolve the axial position of the two image points O1′, O2′ and to obtain the lateral resolution on the value of a focused image despite defocus D1, D2. Due to the different distance between the points O1 and O2, the points O1 and O2 have different point spread functions. The difference of the point spread functions, or the corresponding coherent input ray bundles, allows to infer the 3D position of the first object spot O1 and the second object spot O2. The measurement of the position of the spots can thus allow a conclusion to be drawn about the position of the emission sources.

If the image would be taken in conventional way only in intensity, the lateral resolution would be optimal only if the image is also in focus. Otherwise, the image (composed of the pixels O1′, O2′) would be smeared by the defocus D1, D2, and even numerical post-processing could not recover the information of the optimal focused image.

FIG. 6 shows a schematic representation of a signal processing device 600 described herein for determining an input phase and/or an input amplitude of an input light field Ei. The signal processing device 600 comprises an input module 601 which is arranged to determine a complex interference term from a signal S1, S2, S3 originating from a detector 300. Further, the signal processing device 600 comprises a memory module 602 comprising a propagator mapping and/or a point spread function. “Comprising” in this context may mean that the propagator mapping and/or the point spread function are stored in the memory module 602. In particular, the memory module 602 may comprise a library of multiple, different point spread functions for different distances of the object points. The propagator mapping describes a propagation of a first light field E1 propagated along an optical path length into a second light field E2 propagated along the optical path length, wherein the propagated second light field E2 is defocused relative to the propagated first light field. The signal processing device 600 further comprises an evaluation module 603 configured to determine the input phase and/or the input amplitude of the input light field Ei from the complex interference term and the propagator mapping and/or the point spread function.

With reference to the schematic diagram of FIG. 7, a further embodiment of an interferometer described herein as well as a method described herein will be explained in more detail. The interferometer 100 of FIG. 7 has a two-part splitting device 1011, 1012. A polarizer serves as the amplitude splitter 1011 and as the amplitude superimposer 1012 of the splitting device 1011, 1012, respectively, which causes a rotation of the polarization direction by 45°. In the illustrated embodiment, the defocusing unit 102 includes a birefringent crystal. Further, the two interferometer arms 11, 12 include a phase shifter 2031. The birefringent crystal 102 has different refractive indices for different polarization directions of a light field propagating through the birefringent crystal 102. The phase shifter 2031 causes different phase shifts for different polarization directions of a light field propagating through the phase shifter 2031. The phase shifter 2031 may be electrically controllable.

A polarization of an input light field Ei emanating from an object Oi is rotated by 45° by means of the amplitude splitter 1011. Directly after the amplitude splitter 1011, the light field thus has a perpendicular (approximately 90° polarization) and a parallel (approximately 0° polarization) polarization component (shown schematically in FIG. 7). The perpendicular polarization component corresponds to the second light field E2 and the parallel polarization component corresponds to the first light field E1. The first interferometer arm 11 and the second interferometer arm 12 of the interferometer 100 of FIG. 7 thus differ by the direction of polarization, but may run along the same direction of propagation. However, a spatial division of the two light fields E1, E2 is also possible. For ease of understanding, however, the first light field E1 and the second light field E2 are drawn slightly offset from each other in FIG. 7.

The first light field E1 and the second light field E2 propagate along the two interferometer arms 11, 12 and through the birefringent crystal 102. In the birefringent crystal 102, the first light field E1 and the second light field E2 effectively pass through a different optical medium due to different refractive indices for the two polarization directions. To make the adjustment in optical path length, a layered structure of the birefringent crystal is recommended, where over different materials and different refractive indices the total influence on the optical path is the same for the two polarizations. In the geometric path, the refractive indices enter with a different dependence (1/n instead of n). This shows that the geometric path is different. This allows the second light field E2 to be defocused relative to the first light field E1 while maintaining an identical optical path length.

To compensate for the different optical path lengths, the phases of the two light fields E1, E2 are then shifted relative to each other by means of the phase shifter 2031. After passing through the birefringent crystal 102 and the phase shifter 2031, a propagated first light field U1(E1)*e^{iδ} and a propagated second light field U2(E2) are present. Here, U1 and U2 are each propagator mappings that are the same except for the different propagation in the birefringent crystal 102. Due to the phase shifter 2031, the propagated first light field U1(E1)*e^{iδ} is out of phase relative to the propagated second light field U2(E2). However, the polarization directions of the propagated first light field U1(E1)*e^{iδ} and the propagated second light field U2(E2) are still perpendicular to each other (shown schematically in FIG. 7). By means of the amplitude superimposer 1012, the two propagated light fields are superimposed to form an output light field Ef=U2(E2)+U1(E1)*e^{iδ} and, analogous to the setup of FIG. 1, are brought to interference on a detector 300.

FIG. 8 schematically illustrates another embodiment of an interferometer described herein and a method described herein. In the embodiment example of FIG. 8, the interferometer 100 comprises a two-part splitting device 1011, 1012 with an amplitude splitter 1011 and an amplitude superimposer 1012, each of which is designed as a beam splitter. The input light field Ei is split at the amplitude splitter 1011 into a first light field E1, which passes through a first interferometer arm 11, and a second light field E2, which passes through a second interferometer arm 12. Subsequently, the first light field E1 and the second light field E2 are superimposed at the amplitude superimposer 1012 to form an output light field Ef and are caused to interfere on a detector 300.

The first interferometer arm 11 comprises a first mirror 201 and a first optics system 1021. The second interferometer arm 12 comprises a second mirror 202 and a second optics system 1022. The first optics system 1021 and the second optics system 1021 together form a defocusing unit 1021, 1022. Furthermore, the second interferometer arm 12 comprises a phase shifter 2031, which can be designed analogously to the phase shifter 2031 of the embodiment example of FIG. 7. The first optical system 1021 and the second optical system 1022 have different refractive indices, whereby the principal planes H1, H2 of the first optical system 1021 have a different spacing than the principal planes H1′, H2′ of the second optical system 1022. For example, the first optical system 1021 and the second optical system 1022 each comprise or consist of a dielectric plate. Due to the different position of the principal planes H1,H2,H1′,H2′ of the two optical systems 1021,1022, the first light field E1 and the second light field E2 traverse different geometric path lengths in the two interferometer arms 11,12. The second light field E2 is thus defocused relative to the first light field E1. By means of the phase shifter 2031 as a compensation unit, possible differences in the optical propagation paths can be compensated by a phase shift.

The determination of the point spread function and/or the complex interference term and their evaluation with respect to the input phase and/or input amplitude can be performed, for example, as described below.

According to the usual terminology in optics, a point spread function is the mathematical representation of the light distribution on the detector generated by a point source. Here, object and image lie on conjugate planes except for aberrations. In the following, aberrations are not considered in view of a simpler representation.

In alternative interferometer setups which do not have a defocusing unit as described here, the point spread function is usually determined for the central object point on the optical axis of the system (so-called reference point spread function, PSF0) and all other point spread functions are generated by shifting the reference point spread function. If a point source is shifted in object space, the centre of gravity of the corresponding point spread function also shifts (this applies analogously to the IF point spread function, see below).

In general, the measured intensity image in an imaging system is a superposition of point spread functions centred at different locations and each of these point spread functions corresponds to a spatially shifted reference point spread function. Thus, the intensity image (I) can be represented as follows.

I(x, y)=ΣₛIₛ (8)

where the sum is taken over all point spread functions s of PSF0(x-xs′, y-ys′). Is is the intensity contribution of the point spread function s.

Each point spread function s has a specific location (xs′, ys′) on the detector (with known position zs) and each point spread function s belongs to an object point Pₛ. The object point Pₛ also has coordinates, which are chosen as capital letters to distinguish them: Xs,Ys,Zs. The relation between xs (ys) and Xs (Ys) is given by the mapping, in particular by the mapping between the conjugate planes of the object and the image. The coordinate Zs takes a special position here, because it denotes the distance of the object from the measuring device. If the image plane remains unchanged and Zs is changed, this leads to a defocus (aberration) in the narrow sense of geometrical optics.

The above equation (8) is a convolution equation except for possible coordinate transformations. Via the methods of Fourier analysis (Fourier transform) such a convolution can be represented as a product of the Fourier transforms of the input functions. This allows to determine from the Fourier transform of the measured intensity (x,y) and the Fourier transform of the previously determined PSF0(x,y) by division the respective Fourier transform of Is (Is is a function of s, where s can be e.g. also a two-dimensional coordinate (Xs , Ys)). Is is then calculated from this via back transformation. This method is limited in resolution by the width of the PSF0(x,y) in the Fourier space.

One task of reconstruction in optics is often to determine as well as possible the position Xs,Ys,Zs of the point sources from the measured intensity (x,y) at the detector. This is limited by the lateral resolution (Xs,Ys) and the axial resolution (depth resolution) Zs. The limitation occurs in that different Xs,Ys,Zs lead to point spread functions s which usually cannot be distinguished (i.e. are “equal” considering the measurement inaccuracy).

The situation is usually unfavourable for Zs in alternative interferometer setups, because a variation of Zs is detected via the associated aberration. However, this aberration limits lateral resolution and is generally very inaccurate. Such alternative interferometer setups can have poor depth resolution. The associated depth resolution is a Rayleigh length, where the Rayleigh length is determined for an ideally focused ray bundle from a point source.

In an interferometer described here, the field to be analyzed is the complex interference term (IF). This can be represented as a superposition of its individual terms IFᵢ. The individual terms IFᵢ can be coherent interference terms according to equation (2) or complex point spread functions, hereinafter also referred to as “IF point spread functions”. An IF point spread function is complex-valued.

In an interferometer described herein, the object (e.g., a point source) and the interference pattern (i.e., the image) lie only approximately on conjugate planes. Neither the first interferometer arm 11 nor the second interferometer arm 12 necessarily have a conjugate plane to the object exactly at the location of the detector 300. Typically, this is also not the case in an interferometer described herein, because at least one of the interferometer arms 11, 12 includes a defocusing unit 102, 1021, 1022.

In an interferometer described here, the point spread function for the central object point is usually determined on the optical axis of the system, but now at distance Z (called reference IF point spread function IF-PSF0 (Z)) and all other IF point spread functions for distance Z are generated by shifting the reference IF point spread function for distance Z.

The measured interference pattern of the interferometer is a superposition of the IF point spread function with centres at different locations and each of these IF point spread function corresponds to a spatially shifted IF reference point spread function IF-PSF0 at distance Z. In contrast to the situation with the PSF0, a distinction must be made with the IF-PSF0 according to the distance to the object, because the IF-PSF0 depend significantly on Z.

The interference pattern can be represented according to equation (8) above, now summing over all IF-PSF0. Is is then intensity contribution of the IF point spread function s. Each IF point spread function s has a specific location (xs′, ys′) on the detector and corresponds to a point source distance Zs and each IF point spread function s belongs to an object point Oₛ with coordinates Xs,Ys,Zs (see above).

In contrast to alternative interferometer setups, the situation for Zs in an interferometer described here is much more favourable, because varying Zs changes the reference IF point spread function IF-PSF0 but the width in Fourier space remains almost unchanged, i.e., even if the position of the detection plane is unchanged, this does not lead to a decrease in lateral resolution. By testing IF-PSF0 with different Z on a trial basis, it is possible to determine the correct Z for the point sources. The associated depth resolution is well below the Rayleigh length.

If the object contains different Z, then it is possible, for example, to produce reconstructions at different Zₘ, and to select locally the ‘sharpest’ image in each case. Thus, areas with different Zₘ, can be determined locally. This is a simple proposal for electronic focusing. This does not exclude other methods.

Object reconstruction from the complex interference term may involve determining the positions (Xs,Ys,Zs) and/or intensities (Is) of the object's point sources. Applying the associated point spread function IF-PSF0(X, Y, Z) to the object generally results in the measured interference term. This corresponds to the decomposition of the interference term into different IFᵢ. Within the resolution limits and the measurement errors, this decomposition can be uniquely determined.

The invention is not limited to these by the description based on the embodiments. Rather, the invention encompasses any new feature as well as any combination of features, which in particular includes any combination of features in the patent claims, even if this feature or combination itself is not explicitly stated in the patent claims or embodiments.

### LIST OF REFERENCE SIGNS

First interferometer arm 11
Second interferometer arm 12
Interferometer 100
Splitting device 101
Defocusing unit 102, 1021, 1022
Imaging device 103
First mirror 201
Second mirror 202
Piezo elements 203
Detector 300
Signal processing device 600
Input module 601
Memory module 602
Evaluation module 603
Amplitude splitter 1011
Amplitude superimposer 1012
First optics system 1021
Second optics system 1022
Lenses 1031
Array materials 1032
Phase shifter 2031

1. A method for determining an input phase and/or an input amplitude of an input light field, comprising the following steps:
a) Amplitude splitting of the input light field into a first light field and a second light field;
b) Propagation of the first light field and the second light field such that the propagated second light field is defocused relative to the propagated first light field;
c) Amplitude superposition and imaging of the propagated first light field and the propagated second light field onto a detector in such a way that in each case a first spot of the propagated first light field and a second spot of the propagated second light field interfere on the detector to form a common output spot of an output light field, and the output light field generates an interference pattern at the detector, wherein the respective first spot of the first light field and the respective second spot of the second light field, which interfere to form a common output spot of the output light field, originate from a same input spot of the input light field, and
wherein the output light field has at least three output spots for which applies:
(i) the output light field is free from mutual coherence at different output spots of the at least three output spots, and
(ii) the output light field exhibits at least partial spatial coherence within one output spot of the at least three output spots;
d) measuring at least a portion of the interference pattern with the detector and determining a complex interference term from the measured interference pattern; and
e) At least partially determining the input phase and/or the input amplitude from the complex interference term.

2. The method according to claim 1, wherein the propagated second light field is shifted relative to the propagated first light field along an optical axis.

3. The method according to claim 1, wherein a path difference between the first light field and the second light field is set with an additional adjustment device, wherein the path difference is at least one quarter of the wavelength of the input light field.

4. The method of claim 1, wherein the input light field is emitted from an object having an imaging optical system, and wherein the input light field is a superposition, with respect to a section plane, of mutually incoherent input spots of the input light field, the section plane being at least approximately a conjugate plane of the imaging optical system of the object.

5. The method according to claim 1, wherein a complex spot interference term is determined for each output spot and wherein the complex interference term is represented as a superposition of the complex spot interference terms.

6. The method of claim 1, wherein each output spot is mapped to a plurality of pixels of the detector, wherein a complex pixel interference term is determined for each pixel, and wherein the complex spot interference term consists of the values of the complex pixel interference terms.

7. The method of claim 1, wherein the propagated first light field and the propagated second light field are imaged onto the detector such that the detector is approximately in the image plane of the image.

8. The method of claim 1, wherein measuring at least a portion of the interference pattern includes measuring a phase and an amplitude of the interference pattern.

9. The method of claim 1, further comprising at least one of:
electronically focusing an image based on the input phase or the input amplitude;
correcting the sharpness of an image based on the input phase or the input amplitude;
correcting an aberration of an optical system based on the input phase or the input amplitude;
measuring a surface structure of a three-dimensional object based on the input phase or the input amplitude;
measuring, with temporally partially incoherent light sources or by photoluminescence, an object feature based on the input phase or the input amplitude;
measuring a structure of one or more thin films based on the input phase or the input amplitude;
measuring one or more phase objects based on the input phase or the input amplitude; or
determining a position of an object in a three-dimensional space based on the input phase or the input amplitude.

10. The method of claim 9, comprising:
electronically focusing an image based on the input phase or the input amplitude; or
correcting the sharpness of an image based on the input phase or the input amplitude,
wherein the image is captured with an imaging device, and
wherein the image is captured near a focus of the imaging device but not at the focus of the imaging device.

11. An interferometer for determining an input phase and/or an input amplitude of an input light field, comprising a splitting device, an imaging device, and a detector, wherein
the splitting device defines a first interferometer arm and a second interferometer arm, the second interferometer arm comprising a defocusing unit;
the splitting device is configured to divide the input light field into a first light field and a second light field by means of amplitude splitting;
the splitting device and the imaging device are configured to superimpose the first light field propagated along the first interferometer arm and the second light field propagated along the second interferometer arm by means of amplitude superposition and to image the first light field and the second light field onto the detector in such a manner that in each case a first spot of the first light field and a second spot of the second light field interfere at the detector to form a common output spot of an output light field and the output light field generates an interference pattern at the detector;
the detector is configured to measure at least a portion of the interference pattern;
the defocusing unit is configured to defocus the second light field propagating along the second interferometer arm relative to the first light field; and
the defocusing unit, the splitting device, the imaging device and the detector are configured such that the output spot is incident on a plurality of spot pixels, wherein for at least 10% of the spot pixels a phase difference modulo 2π between the first light field and the second light field at a location of the spot pixels varies by more than 0.1π.

12. The interferometer according to claim 11, wherein the defocusing unit comprises at least one of the following components: a dielectric medium, optionally a dielectric plate; a refractive system, optionally a lens; a diffractive system with a translational symmetry, optionally a grating; an adjustable mirror, optionally a piezo-adjustable mirror.

13. The interferometer according to claim 11, wherein the defocusing unit, the splitting device, the imaging device and the detector are configured such that the output light field has at least three output spots, wherein for the at least three output spots applies:
(i) the output light field is free from mutual coherence at different output spots of the at least three output spots, and
(ii) the output light field exhibits at least partial spatial coherence within an output spot of the at least three output spots.

14. The interferometer according to claim 11, wherein the defocusing unit is configured to change the optical path length of the second interferometer arm.

15. The interferometer according to claim 14, wherein a second geometric propagation distance of the second interferometer arm differs from a first geometric propagation distance of the first interferometer arm by at least 0.1 mm.

16. The interferometer according to claim 11, wherein the interferometer is configured to perform a method according to claim 1.

17. A signal processing device for determining an input phase and/or an input amplitude of an input light field, comprising:
an input module configured to determine a complex interference term from a signal originating from a detector;
a memory module comprising a propagator mapping and/or a point spread function, wherein the propagator mapping describes a propagation of a first light field propagated along an optical path length into a second light field propagated along the optical path length, wherein the propagated second light field is defocused relative to the propagated first light field;
an evaluation module which is configured to determine the input phase and/or the input amplitude of the input light field from the complex interference term and the propagator mapping and/or the point spread function.

18. The signal processing device according to claim 17, wherein the memory module further comprises a reference database, wherein the reference database comprises complex comparison interference terms, wherein the complex comparison interference terms have been determined by means of calculation and/or calibration, and wherein the evaluation module is configured to determine the complex interference term from the signal by means of comparison with the complex comparison interference terms.

19. The interferometer according to claim 12, wherein the defocusing unit consists of at least one of the following components: a dielectric medium, optionally a dielectric plate; a refractive system, optionally a lens; a diffractive system with a translational symmetry, optionally a grating; an adjustable mirror, optionally a piezo-adjustable mirror.

20. The interferometer according to claim 12, wherein the defocusing unit comprises at least one of the following components: a dielectric medium comprising a dielectric plate; a refractive system comprising a lens; a diffractive system with a translational symmetry comprising a grating; an adjustable mirror comprising a piezo-adjustable mirror.
